(19) United States
(12) Patent Application Publication
(10) Pub. No.: US 2003/0071087 A1
(43) Pub. Date: Apr. 17, 2003

(54) DISPENSING APPARATUS WITH REMOTE CONTROL

(76) Inventors: Fredrick B. Jedlicka, Jerseyville, IL (US); Robert W. Haul, St. Louis, MO (US)

Correspondence Address: COHN, POWELL & HIND, P.C., SUITE 103, 7700 CLAYTON RD., ST. LOUIS, MO, 63117, US

(21) Appl. No.: 09/981,574

(22) Filed: Oct. 17, 2001

(51) Int. Cl. B67D 5/06

(52) U.S. Cl. 222/527

(57) ABSTRACT

This dispensing apparatus includes a shut-off valve having an inlet chamber connected to a water supply and an outlet connected to a hose extending to a remote dispensing station. A valve element is provided which separates the inlet chamber from a control chamber but includes passages communicating between said chambers. A servo line connected to the control chamber includes a trigger cut-off valve at the end of the hose remote from the shut-off valve. The trigger cut-off valve is closed to permit pressure build-up in the control chamber to close the valve element and the trigger cut-off valve is opened to relieve pressure in the control chamber and open the shut-off valve and permit liquid to be dispensed.

### BACKGROUND OF THE INVENTION

This invention relates generally to dispensing apparatus and particularly to a shut-off valve having a hydraulically operated remote control trigger cut-off.

It is possible to control the water flowing through a hose used for remote operation by providing a trigger cut-off device at the end of the hose, for example, by means of an outlet control nozzle such as the common garden hose nozzle. The disadvantage of this control method is that when the hose is not being used, the water in it is under pressure and can be damaged if run over by a truck, for example. Accordingly, dispensers of the type under consideration have a shut-off valve close to the water source.

Unfortunately, when the water shut-off valve is at a water supply station remote from the end of the hose line, the operator must return to the water supply station to shut-off or restart the valve, which is a constant waste of operator time.

One solution is to provide a caliper-like remote operation by which the operator is provided at the remote end of the hose line with a trigger mechanism which is connected by a wire to the valve actuator, such as a push button, which is mechanically operated by the wire. In such devices, the necessary tension in the caliper wire requires constant adjustment to provide the correct amount of movement to actuate the valve properly.

This remotely actuated dispenser overcomes these and other problems in a manner not revealed in the known prior art.

### SUMMARY OF THE INVENTION

This dispenser is particularly suitable for control of hoses which are used to fill containers at a remote operation and is suitable for use with a single liquid or with a mixed liquid such as a diluent detergent. The remote control actuates the valve shut-off valve hydraulically without the need for using control wires extending over long distances from the hose end to the valve.

The dispensing apparatus comprises a valve including: an inlet, an inlet chamber communicating with the inlet, an outlet, a valve seat between the inlet chamber and the outlet and a valve element movable from a closed position restricting flow through the valve seat to an open position permitting flow through the valve seat, and a control chamber separated from the inlet chamber by the valve element means for communicating between the inlet chamber and the control chamber. A main line is connected to the outlet and extends to a remote dispensing station. A servo line is connected to the control chamber and has a cut-off valve remote from said control chamber; the cut-off valve being closed to permit pressure build up in the control chamber to close the valve element and the cut-off valve being opened to relieve pressure in the control chamber and open the shut-off valve.

It is an aspect of this invention to provide that the main line includes a dual passage hose, one of said passages carrying liquid to the remote dispensing point and the other of said passages carrying the sensor line.

It is another aspect of this invention to provide that the means for communicating between the inlet chamber and the control chamber includes at least one opening in the valve element separating the inlet chamber from the control chamber.

It is yet another aspect of this invention to provide that the servo line cut-off valve includes means for pinching the servo line and shutting off flow therethrough, and another aspect to provide that the cut-off valve includes a slide valve for interrupting flow through the servo line.

It is still another aspect of this invention to provide that the means for pinching the sensor line includes an adaptor attached to the main line and having a trigger pivotally attached to the adaptor. The trigger includes a handle portion and a pinching portion, the handle portion being movable so that the pinching portion engages and pinches the servo line to cut off flow therethrough.

It is an aspect of this invention to provide a shut-off valve having an inlet, an outlet and a valve element therebetween; and hydraulic means for moving the valve element between an open and closed position and another aspect to provide a main line connected to the outlet and extending to a remote dispensing station; and remote control means for controlling the hydraulic means including a servo line extending from the hydraulic means to the dispensing station.

This invention provides a remotely controlled dispenser which is simple and inexpensive to manufacture and is highly efficient for its intended purpose.

### BRIEF DESCRIPTION OF THE DRAWINGS

FIG. 1 is an elevational view of the dispenser and hose assembly;

FIG. 2 is an enlarged cross-sectional view taken on Line 2-2 of FIG. 1;

FIG. 3 is an enlarged view of the shut-off valve;

FIG. 4 is a fragmentary view showing the pinch cut-off valve in the closed position;

FIG. 5 is a cross-sectional view taken on line 5-5 of FIG. 4;

FIG. 6 is an enlarged view showing the holding pin taken on line 6-6 of FIG. 4;

FIG. 7 is a modified device showing a slide type cut-off valve in the closed position;

FIG. 8 is a cross-sectional view taken on line 8-8 of FIG. 7; and

FIG. 9 is a cross-sectional view taken on line 9-9 of FIG. 8.

### DESCRIPTION OF THE PREFERRED EMBODIMENT

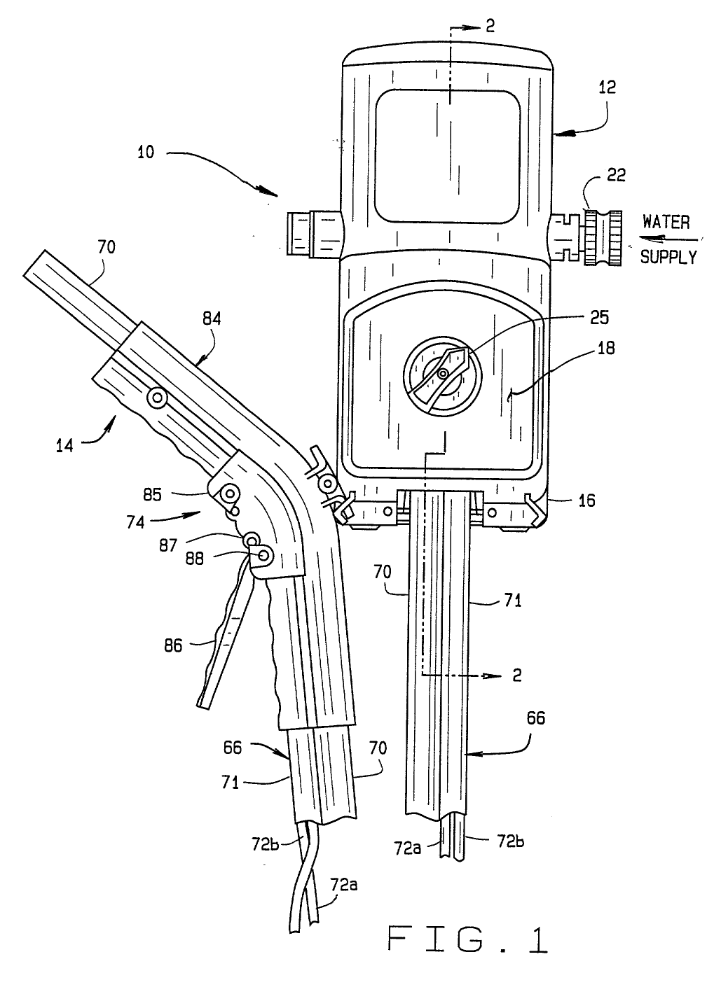

Referring now by reference numerals to the drawings and first to FIGS. 1-4, it will be understood that the dispensing apparatus 10 includes a dispenser 12 and a remote delivery system 14. The dispenser 12 includes a base 16, which may be mounted to a wall, and a cover 18.

Mounted to the base 16 is a shut-off valve 20 supplying liquid, for example water, by way of a supply line 22 to a dispensing device, generally indicated by numeral 24. The dispensing device 24 may be a proportioner of the type indicated in copending U.S. patent application Ser. No. 09/921,399 or in U.S. Pat. No. 5,797,420 both of which are commonly owned by the assignee of the present invention and are incorporated herein by reference. The dispensing device 24 therefore may include a backflow preventer 26 and a proportioner 28 which draws a second liquid such as detergent, into a venturi 29 through an inlet 30 for mixing by the dispensing device and discharge through an outlet 32. The dispensing device 24, which may have a selector switch 25, is not itself part of the invention and the dispensing device may be used to dispense liquid only, to a remote downstream station (not shown) at the end of the delivery system 14. To this end, the shut-off valve 20 may be considered as a means for dispensing liquid directly through the valve outlet to a hose 66, or to a proportioner for dispensing a liquid mixture through said outlet 32 to the main line 70 of the hose 66.

Essentially, the shut-off valve 20 includes a trigger control cut-off system located, in part, downstream at the remote end of the delivery system 14 as will now be described.

As best shown in FIG. 3, the shut-off valve 20 includes a body 40 having a threadedly connected cap 42. An inlet 44 is connected between the water supply line 22 and an inlet chamber 46. The valve 20 also includes an outlet 48 having a valve seat 50 at its upper end and a valve element 52 which, in FIG. 3, is shown in a closed position. The valve element 52 is movable from the closed position restricting flow through the valve seat 50 to an open position permitting flow through the valve seat 50. A control chamber 54 is provided on the upper side of the valve element 52. The valve 20 is in an open or closed position depending on the difference between the closing force exerted on the upper face 56 of the valve element 52, by the pressure in the control chamber 54, and the opening force exerted on the lower face 58 of the valve element 52 by the water pressure in the inlet chamber 46.

In the embodiment shown, the valve element 52 includes a body 60, and an annular web 62 having an outer ring 65, and constitutes a diaphragm. As shown in FIG. 3, the valve element ring 65 is clamped in place between the valve body 40 and the valve cap 42 and the web 62 is apertured to provide one or more bleed holes 64 connecting the inlet chamber 46 to the control chamber 54.

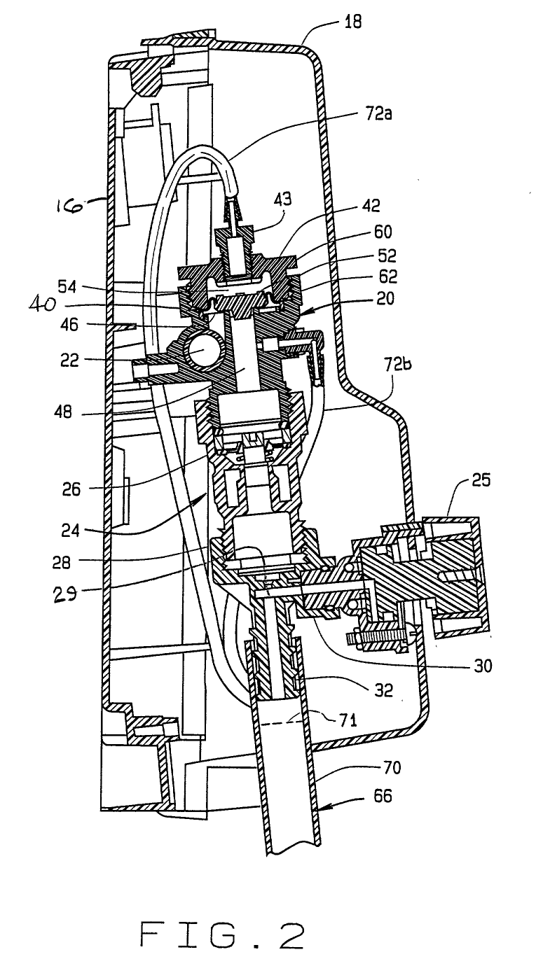

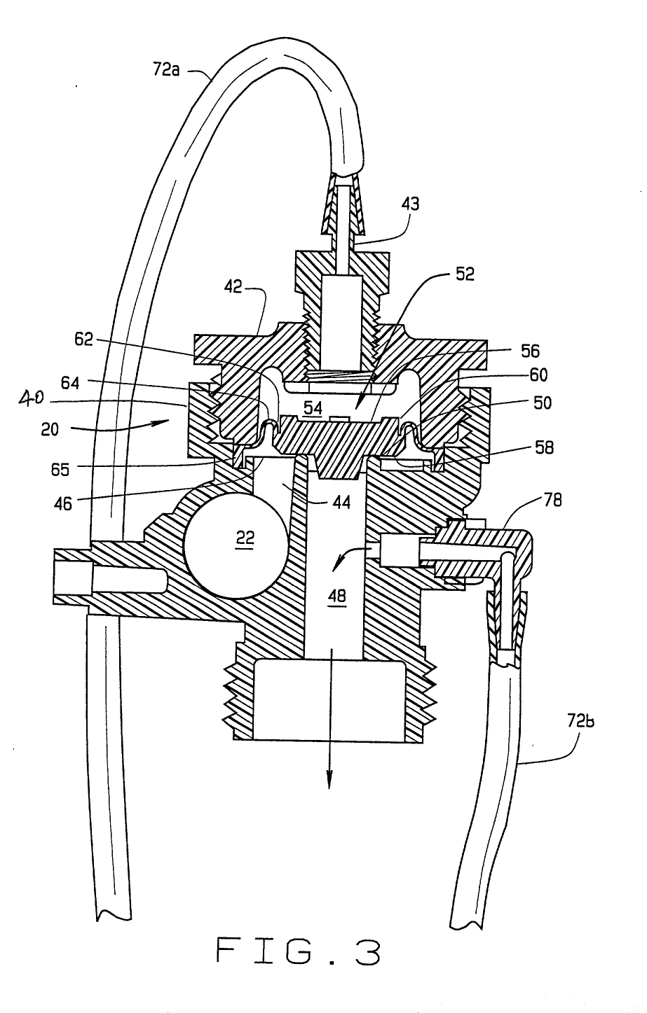

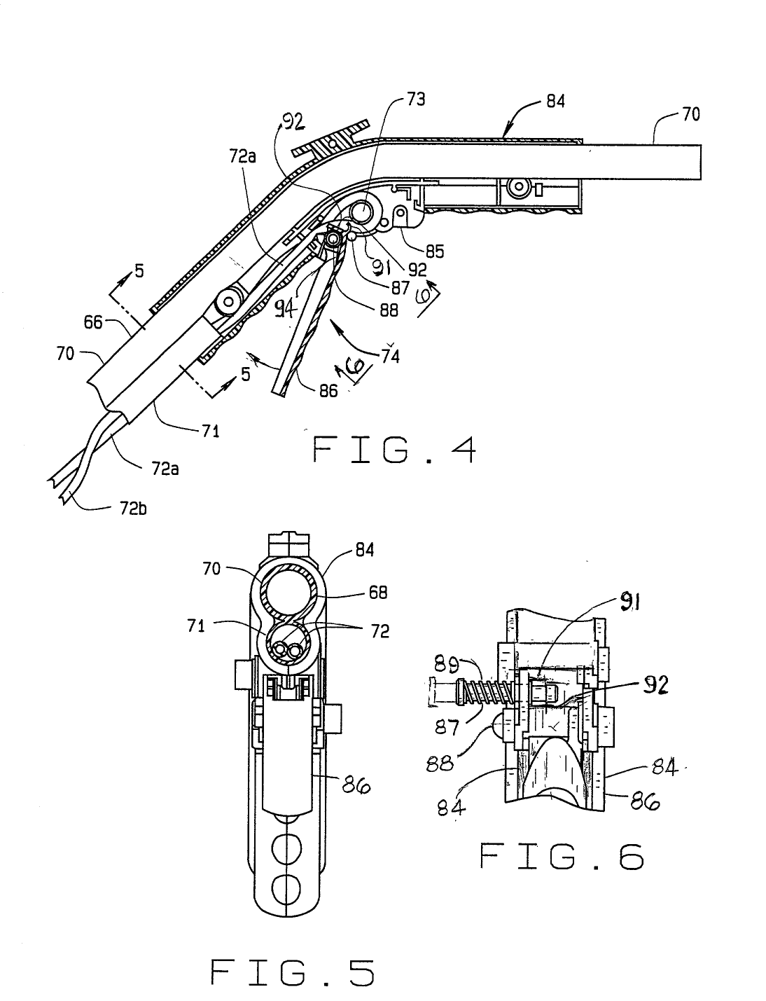

The remote delivery system 14 as best shown in FIG. 1 includes the main line 70, which is connected to the outlet 32 as shown in FIG. 2, and a servo line 72 having ends 72a and 72b. The servo line 72, as shown in FIG. 3, is connected to the control chamber 54 at end 72a by means of a connector 43. The servo line 72 is turned around a spool 73 (FIG. 4) intermediate its ends and is connected to the valve 20 at its return end 72b by a connector 78 (FIG. 3). Adjacent to the spool 73 the servo line 72 includes a trigger cut-off valve 74 which is shown closed in FIG. 4, When the trigger cut-off valve 74 is opened, the water in the servo line end 72b is returned to the shut-off valve outlet 48. This arrangement is best shown in FIG. 3.

As will be discussed below, the trigger cut-off valve 74 in the preferred embodiment is provided by a pinch mechanism acting on the servo line 72.

As best shown in FIGS. 3-5, when the water supply is activated, as by turning on a water supply faucet (not shown) water enters the inlet chamber 46 by way of the water supply line 22 and the inlet 44. At this time, the trigger cut-off valve 74 is closed and water entering the control chamber 54 through the diaphragm bleed holes 64 provides a closing force on the control side of the valve element 52. The closing force on the valve element 52 is greater than the opening force on the inlet chamber side due to the greater upper face area 56 compared to the lesser lower face area 58. When the trigger cut-off valve 74 is opened, the pressure in the control chamber 54 is relieved through connector 43, servo line 72 and connector 78 to valve outlet 48, and the valve element 52 moves upwardly away from the valve seat 50 with the result that liquid enters the outlet 48 and issues from the end of the hose 70 at the remote station. When the trigger cut-off valve 74 is again closed, pressure builds up in the control chamber 54 and the valve element 52 moves down closing valve 20 effectively shutting off the water supply.

It is important to note that, in order for this remotely operated trigger cut-off valve 74 to function properly the servo line 72 must provide less restriction to flow than the restriction of flow between the inlet chamber 46 and the control chamber 54. In the embodiment shown, the flow restriction is the result of water passing internally between the inlet chamber 46 and the control chamber 54 through bleed holes 64 in the valve element 52. However, it will be understood that water from the inlet chamber 46 could also pass by a direct external line (not shown) from the inlet to the control chamber 54 in lieu of using bleed holes. In the embodiment shown, the flow restriction between the inlet chamber 46 and the control chamber 54 is determined essentially by the size and number of the bleed holes 64. The flow restriction in the servo line 72 depends on the diameter and length of the servo line 72 between the control chamber 54 and the trigger cut-off valve 74 and the length of the return servo line 72 between the trigger cut-off valve 74 and the shut-off valve outlet 48.

When the trigger cut-off valve 74 is closed, flow from the control chamber 54 is prevented and a static condition exists. At this time, the inlet pressure is experienced on all of the valve element 52 in the control chamber 54 and only on an annular portion of the valve element 52 on the side opposite to the control chamber 54. The rest of the area of the valve element 52 on the side opposite the control chamber 54 is exposed to the outlet pressure in 48. The result of this is that the valve element body 60 is forced onto the seat 50 and prevents flow through the shut-off valve 20.

When the trigger cut-off valve 74 is open to allow flow from the control chamber 54 to a lower pressure location, at the return end of the servo line 72, a dynamic condition exists with pressure in the control chamber 54 rapidly approaching said lower pressure. Initially, the inlet pressure is experienced on only an annular portion of the valve element 52 on the side opposite the control chamber 54. The rest of the area of the valve element 52 covers the valve seat 50 and is exposed to the lower outlet pressure. However, the sum of these two forces is now greater than the force exerted in the control chamber 54 which forces the valve element 52 to lift off the seat and allows flow through the shut-off valve 20. Normally, a servo operator, such as the trigger cut-off valve 74, is attached directly to the valve body close to the valve element 52. By the present arrangement the servo operator, that is the trigger cut-off valve 74, may be located remotely from the valve element 52, the distance from the control chamber 54 being limited only by flow through the trigger cut-off valve 74. This flow must be sufficient to allow the shut-off valve 20 to operate as described.

In the preferred embodiment shown, the trigger cut-off valve 74, which operates by pinch action, will now be described by reference to FIGS. 4 and 5.

The hose 66, in the embodiment shown, includes an auxiliary portion 71 unitarily formed with the main line portion 70 and providing a protective sheath for the servo line 72.

The hose 66 is provided with a trigger housing 84, which is configurated to receive the dual hose 66 as shown in FIGS. 4 and 5. The trigger housing 84 includes an intermediate bracket 85 pivotally mounting a trigger 86 by means of a pivot 88 and a hair pin spring 94. The spring tends to urge the trigger 86 away from the housing so that the trigger pinch point provided by the L-shaped end 92 cuts off water flow through the servo line 72. This cut-off pinching position is maintained until the trigger 86 is moved clockwise by an operator, as shown by the arrow in FIG. 4. Only a short arcuate movement is required and when this occurs, the pinching action is relieved, lowering the pressure in the control chamber 54 and opening the shut-off valve 20 resulting in a stream of liquid issuing from the remote end of the hose main line portion 70. The liquid stream continues through the hose during the time that the trigger 86 is maintained in the clockwise position. The bracket 85 may include a holding means such as a pin 87 having a spring 89 shown in FIG. 6 which, when activated, prevents the return of the trigger 86 into the pinched closed valve position shown in FIG. 4 until the pin 87 is released by the operator. The pin may be used when trigger cut-off valve 74 is to be held in the open position for an extended period of time. In the embodiment shown in FIG. 4, the trigger 86 at its pivot end includes an arcuate projection 91. When the trigger 86 is rotated clockwise a short distance, the arcuate projection 91 is positioned below the holding pin 87 and the pin 87 can be pushed into the arcuate projection to be held by pin pressure against the projection 91 so that the trigger 86 is maintained in the non-cut off free flow condition without having to be held by the operator. When it is desired to again cut off flow it is simply a matter of applying a light clockwise pull on the trigger 86 so that the pin 87 is urged outwardly by the spring 89 to allow the trigger 86 to move again into the pinch position. When the trigger 86 is released in this way, it automatically returns counterclockwise to the pinching position shown in FIG. 4 thereby shutting off pinch valve 74 and permitting water pressure to build up in the control chamber 54 close the valve 20 and shut-off flow through hose main line 70.

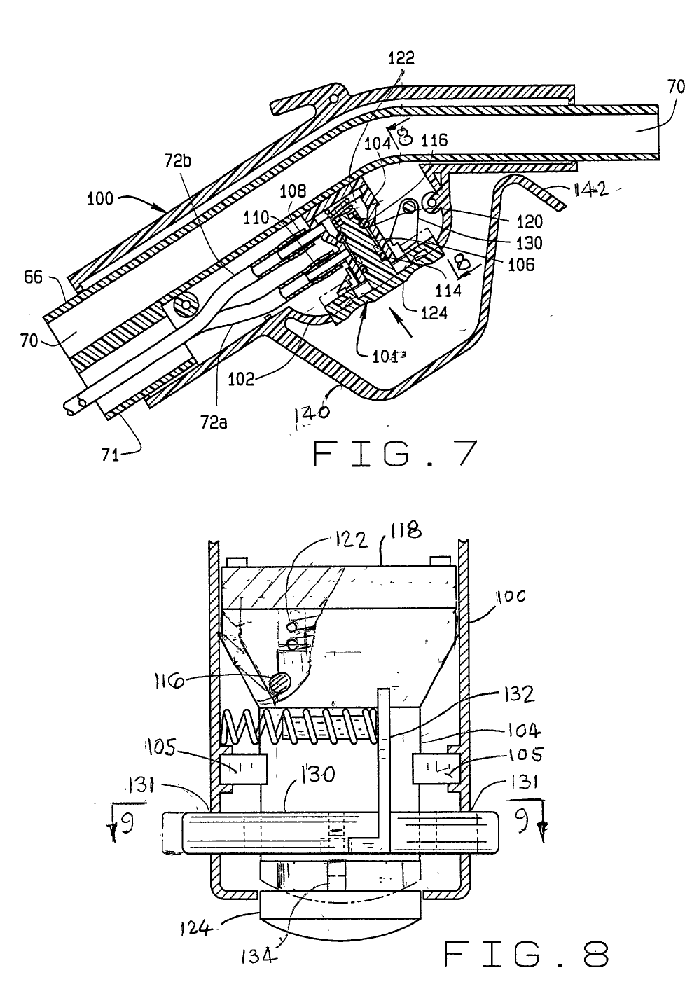

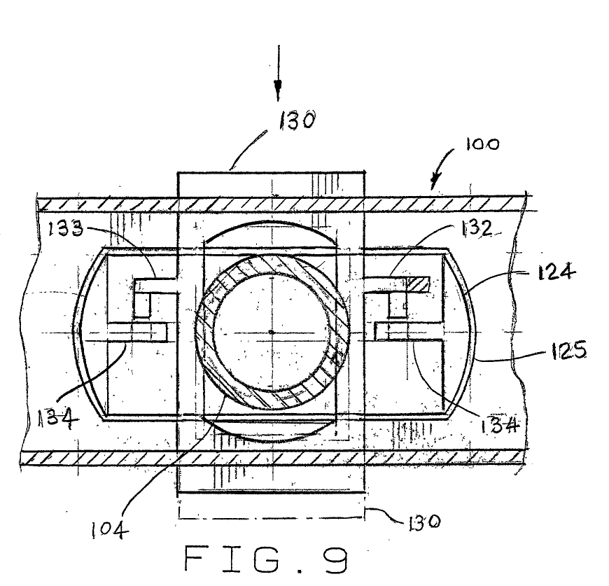

A modified cut-off valve is shown in FIGS. 7-9.

As in the first embodiment, the hose 66 includes an auxiliary portion 71 unitarily formed with the main line portion 70 and providing a protective sheath for the servo line 72.

Distinguishing from the first embodiment, the hose 66 is provided with a valve housing 100 which includes an intermediate bracket 102 supporting a fixed tubular body 104 and a sliding piston 106 cooperating to provide a slide type cut-off valve 101. As shown, the tubular body 104 includes upper and lower barb connections 108 and 110 receiving servo line ends 72b and 72a, respectively, in sealed relation. Also, the tubular body 104 includes projections 105 by which it is mounted to the bracket 100.

The piston 106 extends upwardly from a hand-graspable trigger base 124 and includes lower and upper O-ring seals 114 and 116 respectively which cooperate to define an annular chamber 120. The piston 106 is urged into its lower cut off position by a spring 122 between the top of the piston 106 and the underside of a cap 118. In its lower position, shown in FIG. 8, the sealed annular chamber 120 communicates with the lower barb connection 110 and the servo line end 72a. In the position shown, the servo line end 72a is closed, the annular chamber 120 is under pressure from the shut-off valve control chamber 54, the shut-off valve 20 is closed and there is no water flow through the main line 70. The upper O-ring seal is larger than the lower O-ring seal so that it acts as a stop against downward movement of the piston.

This cut-off position is maintained until the hand-graspable base trigger 124 is pulled upwardly in the direction of the arrow shown in FIG. 7. When this occurs, the servo line cut-off action is relieved allowing water from servo line end 72a to enter servo line 72b for discharge into the valve outlet 48. When pressure in the servo line end 72a is relieved, the pressure in the control chamber 54 is lowered, the valve element 52 is raised and the shut-off valve 20 is opened resulting in a stream of liquid issuing from the remote end of the hose main line portion 70. The liquid stream continues through the hose during the time that the base trigger 124 is maintained in the upward position.

The assembly may include a holding means such as a locking plate 130 which is held in sliding relation within openings in the sidewalls of the housing 100. The locking plate 130 includes integrally formed L-shaped members 132 and 133 and the upper portion of the trigger base is provided with slotted cooperating members 134 which receive the lower end of the L-shaped members in holding relation when the locking plate is pushed into engagement with said cooperating members 134 and which, when moved to the locking position, prevents the return of the base trigger into the closed valve position until the locking plate 130 is released by the operator. The locking plate 130 may be used when base trigger cut-off valve 101 is to be held in the open position for an extended period of time. When the locking plate 130 is moved in the opposite direction by the operator to disengage the trigger base 124, it is automatically urged downwardly under spring pressure to the cut-off position shown in FIG. 8, at which time the water supply is cut off.

In the embodiment shown, the housing 100 includes an integrally formed flexible guard 140 which provides a clip 142 by which the housing may be held in place against a pail (not shown) or similar container.

Although the dispenser has been described by making detailed reference to a preferred embodiment, the details of the description are not be understood as restrictive numerous variants being possible within the scope of the claims hereunto appended.

We claim as our invention.

1. A dispensing apparatus with remote control comprising:
a shut-off valve including an inlet, an inlet chamber communicating with the inlet, an outlet, a valve seat between the inlet chamber and the outlet and a valve element movable from a closed position restricting flow through the valve seat to an open position permitting flow through the valve seat, and a control chamber separated from the inlet chamber by the valve element and means for communicating between the inlet chamber and the control chamber;
a main line connected to the outlet and extending to a remote dispensing station; and
a servo line connected to the control chamber and having a cut-off valve remote from said control chamber; the cut-off valve being closed to permit pressure build up in the control chamber to close the valve element and the cut-off valve being opened to relieve pressure in the control chamber and open the shut-off valve.

2. A dispensing apparatus as defined in claim 1, wherein:
the main line includes a dual passage hose one of said passages carrying liquid to the remote dispensing point and the other of said passages carrying the sensor line.

3. A dispensing apparatus as defined in claim 1, wherein:
the means for communicating between the inlet chamber and the control chamber includes at least one opening in the valve element separating the inlet chamber from the control chamber.

4. A dispensing apparatus as defined in claim 1, wherein:
the servo line trigger cut-off valve includes means for pinching the servo line and shutting off flow therethrough.

5. A dispensing apparatus as defined in claim 4, wherein:
the cut-off valve includes a pivotally mounted trigger.

6. A dispensing apparatus as defined in claim 4, wherein:
the means for pinching the sensor line includes an adaptor attached to the main line and having a trigger pivotally attached to the adaptor, and having a pinching portion the trigger being movable so that the pinching portion engages and pinches the servo line to cut-off flow therethrough.

7. A dispensing apparatus as defined in claim 5, wherein:
the servo line cut-off valve includes means for holding the trigger in an open flow condition.

8. A dispensing apparatus as defined in claim 1, wherein:
the servo line cut-off valve includes a slide valve for interrupting flow through the servo line.

9. A dispensing apparatus as defined in claim 8, wherein:
the servo line cut-off valve includes means for holding the slide valve in an open flow condition.

10. A dispensing apparatus comprising:
a shut-off valve having an inlet, an outlet and a valve element therebetween;
hydraulic means for moving the valve element between an open and closed position;
a main line connected to the outlet and extending to a remote dispensing station; and
remote control means for controlling the hydraulic means including a servo line extending from the hydraulic means to the dispensing station.
